(19) United States
(12) Patent Application Publication
(10) Pub. No.: US 2024/0154189 A1
(43) Pub. Date: May 9, 2024

(54) Battery Management Device

(71) Applicant: Prime Planet Energy & Solutions, Inc., Tokyo (JP)

(72) Inventors: Masato NAKAYAMA, Akashi-shi (JP); Masanori ITOU, Kasai-shi (JP)

(21) Appl. No.: 18/477,554

(22) Filed: Sep. 29, 2023

(30) Foreign Application Priority Data
Nov. 4, 2022 (JP) 2022-177309

(51) Int. Cl. H01M 10/42; H01M 10/48; H02J 7/00

(52) U.S. Cl. CPC H01M 10/4264; H01M 10/48; H02J 7/0047; H02J 7/0063; H01M 2010/4271

(57) ABSTRACT

An amount of heat generated in a substrate is suppressed when discharging a battery. When a first switch is in a conductive state, power of a first battery is consumed by a first resistance element provided in a first wiring and a second resistance element provided in a substrate.

### CROSS REFERENCE TO RELATED APPLICATIONS

This nonprovisional application is based on Japanese Patent Application No. 2022-177309 filed on Nov. 4, 2022 with the Japan Patent Office, the entire contents of which are hereby incorporated by reference.

### BACKGROUND OF THE INVENTION

### Field of the Invention

The present disclosure relates to a battery management device.

### Description of the Background Art

For example, Japanese Patent Laying-Open No. 2021-068696 discloses a power storage module. The power storage module includes: a plurality of batteries; and a control unit that monitors a voltage of each of the plurality of batteries, or the like. Further, the control unit performs discharging control for the battery.

### SUMMARY OF THE INVENTION

In the above-described technology, for example, the following configuration is conceivable: power of the battery is consumed by a resistance element provided on a substrate, thereby performing the discharging control for the battery. However, with such a configuration, an abnormality may occur in the substrate when an amount of heat generated in the resistance element becomes large.

The present disclosure has been made to solve the above-described problem, and has an object to suppress an amount of heat generated in a substrate when discharging a battery.
(Item 1) A battery management device of the present disclosure includes: a battery; a substrate; a switch; a first wiring that connects the battery and the substrate; a first resistance element disposed on the first wiring; and a second resistance element disposed on the substrate. When the switch is in a conductive state, power of the battery is consumed by the first resistance element and the second resistance element.
(Item 2) In the battery management device according to item 1, a ratio of an amount of heat generated in the first wiring and an amount of heat generated in the substrate is the same as a ratio of a resistance value of the first resistance element and a resistance value of the second resistance element.
(Item 3) The battery management device according to item 1 or 2 further includes a first sensor, a second sensor, and a controller that receives an input of a detection value of each of the first sensor and the second sensor. When the switch is in the conductive state, the first sensor outputs a first voltage value of the battery having been decreased in voltage by the first resistance element.

When the switch is in the conductive state, the second sensor outputs a second voltage value of the battery having been decreased in voltage by the first resistance element and the second resistance element. The controller detects an abnormality based on a difference value between the first voltage value and the second voltage value.
(Item 4) In the battery management device according to item 3, when the switch is in a non-conductive state, the controller detects the abnormality if the difference value is larger than a threshold value, and a ratio of a permissible error of the first sensor and the threshold value is the same as a ratio of the resistance value of the first resistance element and the resistance value of the second resistance element.
(Item 5) In the battery management device according to any one of items 1 to 4, the first wiring is connected to a positive electrode of the battery. The battery management device further includes: one first terminal that connects the first wiring and the substrate; a second wiring connected to a negative electrode of the battery; and one second terminal that connects the second wiring and the substrate.
(Item 6) The battery management device according to item 5 further includes a third resistance element disposed on the second wiring. The resistance value of the first resistance element is more than or equal to a value obtained by dividing, by a rated power value of the first resistance element, a square value of a value obtained by prorating a maximum voltage value of the battery at a ratio of the resistance value of the first resistance element and a resistance value of the third resistance element.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an exemplary configuration of a battery management device according to the present embodiment.

FIG. 2 is a diagram for illustrating a case where a first switch is in a conductive state.

FIG. 3 is a diagram showing a configuration of a battery management device according to a first comparative example.

FIG. 4 is a diagram showing a configuration of a battery management device according to a second comparative example.

FIG. 5 is a diagram showing a configuration of a battery management device according to a third comparative example.

### DESCRIPTION OF THE PREFERRED EMBODIMENTS

Hereinafter, embodiments of the present disclosure will be described in detail with reference to figures. It should be noted that in the figures, the same or corresponding portions are denoted by the same reference characters and will not be described repeatedly.

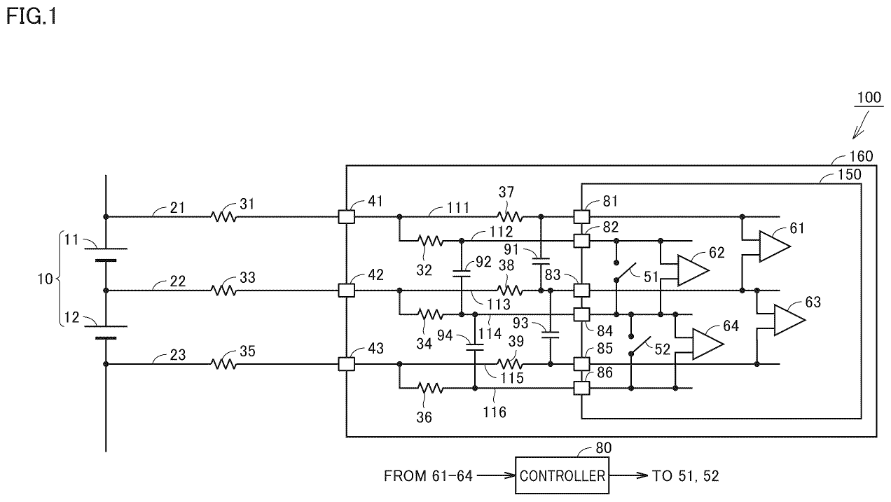

FIG. 1 is a diagram showing an exemplary configuration of a battery management device 100 according to the present embodiment. Battery management device 100 includes a battery group 10, a substrate 160, and a controller 80. Battery group 10 includes a first battery 11 and a second battery 12. Each of first battery 11 and second battery 12 is a chargeable/dischargeable battery such as a lithium ion battery or nickel-metal hydride battery. In the example of FIG. 1, first battery 11 and second battery 12 are connected in series. The number of batteries included in the battery group may be three or more. It should be noted that some portions are not illustrated in the figures of the battery circuit device of the present disclosure. For example, no load to which battery group 10 supplies power is illustrated.

Battery management device 100 includes a below-described first sensor 61 and a below-described third sensor 63. When each of a below-described first switch 51 and a below-described second switch 52 is in a non-conductive state, first sensor 61 detects a voltage value of first battery 11, and third sensor 63 detects a voltage value of second battery 12. The voltage value detected by first sensor 61 and the voltage value detected by third sensor 63 are output to controller 80. Controller 80 estimates a capacity value of first battery 11 and a capacity value of second battery 12 based on the voltage value from first sensor 61 and the voltage value from third sensor 63. Controller 80 controls below-described first switch 51 and below-described second switch 52 based on the capacity value of first battery 11 and the capacity value of second battery 12. It should be noted that as a modification, controller 80 may control below-described first switch 51 and below-described second switch 52 based on the voltage value detected by first sensor 61 and the voltage value detected by third sensor 63.

Battery management device 100 further includes a first wiring 21, a second wiring 22, a third wiring 23, a first terminal 41, a second terminal 42, and a third terminal 43. Battery group 10 is connected to substrate 160 via first terminal 41, second terminal 42, and third terminal 43.

One end of first wiring 21 is connected to a positive terminal of first battery 11, and the other end of first wiring 21 is connected to substrate 160 via first terminal 41. One end of second wiring 22 is connected to a negative terminal of first battery 11 and a positive terminal of second battery 12, and the other end of second wiring 22 is connected to substrate 160 via second terminal 42. One end of third wiring 23 is connected to a negative terminal of second battery 12, and the other end of third wiring 23 is connected to substrate 160 via third terminal 43. A first resistance element 31 is disposed on first wiring 21, a third resistance element 33 is disposed on second wiring 22, and a fifth resistance element 35 is disposed on third wiring 23.

Substrate 160 includes a first terminal 81, a second terminal 82, a third terminal 83, a fourth terminal 84, a fifth terminal 85, a sixth terminal 86, a first wiring 111, a second wiring 112, a third wiring 113, a fourth wiring 114, a fifth wiring 115, and a sixth wiring 116. Further, a measurement circuit 150 is mounted on substrate 160.

One end of first wiring 111 is connected to first terminal 41, and the other end of first wiring 111 is connected to measurement circuit 150 via first terminal 81. One end of second wiring 112 is connected to first terminal 41, and the other end of second wiring 112 is connected to measurement circuit 150 via second terminal 82. One end of third wiring 113 is connected to second terminal 42, and the other end of third wiring 113 is connected to measurement circuit 150 via third terminal 83. One end of fourth wiring 114 is connected to second terminal 42, and the other end of fourth wiring 114 is connected to measurement circuit 150 via fourth terminal 84. One end of fifth wiring 115 is connected to third terminal 43, and the other end of fifth wiring 115 is connected to measurement circuit 150 via fifth terminal 85. One end of sixth wiring 116 is connected to third terminal 43, and the other end of sixth wiring 116 is connected to measurement circuit 150 via sixth terminal 86.

Substrate 160 further includes a second resistance element 32, a fourth resistance element 34, a sixth resistance element 36, a seventh resistance element 37, an eighth resistance element 38, a ninth resistance element 39, a first capacitor 91, a second capacitor 92, a third capacitor 93, and a fourth capacitor 94.

A second resistance element 32 is disposed on second wiring 112. A fourth resistance element 34 is disposed on fourth wiring 114. A sixth resistance element 36 is disposed on sixth wiring 116. A seventh resistance element 37 is disposed on first wiring 111. An eighth resistance element 38 is disposed on third wiring 113. A ninth resistance element 39 is disposed on fifth wiring 115.

Measurement circuit 150 has first sensor 61, a second sensor 62, third sensor 63, a fourth sensor 64, first switch 51, and second switch 52. First sensor 61, second sensor 62, and first switch 51 correspond to first battery 11. Third sensor 63, fourth sensor 64, and second switch 52 correspond to second battery 12. Each of first sensor 61, second sensor 62, third sensor 63, and fourth sensor 64 detect a voltage value. The voltage value will be described later. Each of first sensor 61 and third sensor 63 is also referred to as a “main sensor”, and each of second sensor 62 and fourth sensor 64 is also referred to as an “auxiliary sensor”.

Seventh resistance element 37, eighth resistance element 38, and first capacitor 91 constitute an RC filter for first sensor 61. Second resistance element 32, fourth resistance element 34, and second capacitor 92 constitute an RC filter for second sensor 62. Eighth resistance element 38, ninth resistance element 39, and third capacitor 93 constitute an RC filter for third sensor 63. Fourth resistance element 34, sixth resistance element 36, and fourth capacitor 94 constitute an RC filter for fourth sensor 64. Since the respective RC filters are constructed for the sensors in this way, noise input to each sensor is reduced.

Further, first battery 11 and second battery 12 may be charged or discharged in a state in which a difference value between the capacity value of first battery 11 and the capacity value of second battery 12 is large. In this case, in the event of charging, the battery having a larger capacity is fully charged first, and the battery having a smaller capacity is not fully charged by the difference value between the capacities. Meanwhile, in the event of discharging, the capacity of the battery having a smaller capacity becomes zero first, and the batteries including the battery having a larger capacity are not discharged further. That is, there unfavorably occurs such a phenomenon that a usable battery capacity value is decreased by the difference value between the capacities. Therefore, the difference value between the capacity value of first battery 11 and the capacity value of second battery 12 is preferably small.

Therefore, when the difference value between the capacity value of first battery 11 and the capacity value of second battery 12 is larger than a capacity threshold value, battery management device 100 discharges the battery having a larger capacity value. Specifically, when the difference value between the capacity value of first battery 11 and the capacity value of second battery 12 is larger than the capacity threshold value, controller 80 controls a switch corresponding to the battery having a larger capacity value to come into a conductive state (on state). Further, controller 80 controls a switch corresponding to the battery having a smaller capacity value to come into a non-conductive state (off state).

Specifically, when the difference value is larger than the capacity threshold value, if the capacity value of first battery 11 is larger than the capacity value of second battery 12, controller 80 controls first switch 51 to come into the conductive state and controls second switch 52 to come into the non-conductive state. With such control, the power (capacity) of first battery 11 can be consumed by first resistance element 31, second resistance element 32, third resistance element 33, and fourth resistance element 34.

When the difference value is larger than the capacity threshold value, if the capacity value of second battery 12 is larger than the capacity value of first battery 11, controller 80 controls second switch 52 to come into the conductive state and controls first switch 51 to come into the non-conductive state. With such control, the power (capacity) of second battery 12 can be consumed by third resistance element 33, fourth resistance element 34, fifth resistance element 35, and sixth resistance element 36.

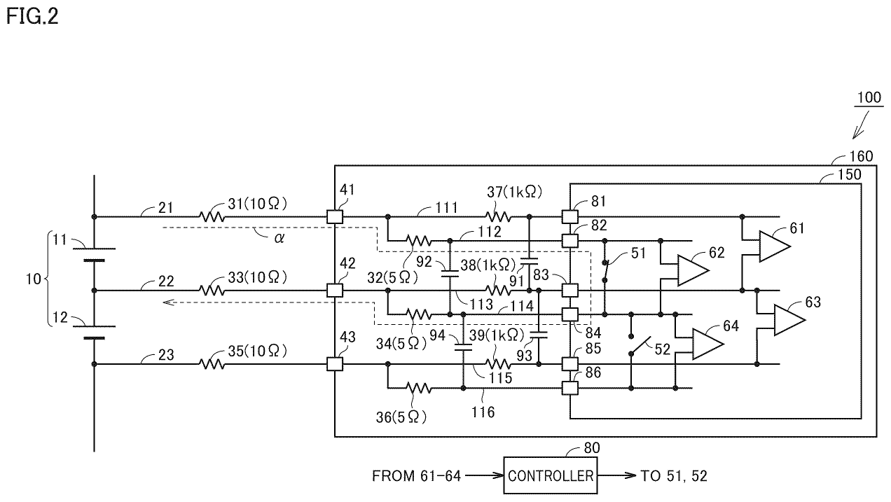

FIG. 2 is a diagram for illustrating the case where first switch 51 is in the conductive state. This case is a case where the capacity value of first battery 11 is larger than the capacity value of second battery 12 when the difference value is larger than the capacity threshold value. An arrow a in FIG. 2 represents a flow of current of first battery 11. In the example of FIG. 2, first resistance element 31, third resistance element 33, and fifth resistance element 35 have the same resistance value of 10Ω. Second resistance element 32, fourth resistance element 34, and sixth resistance element 36 have the same resistance value of 5Ω. Seventh resistance element 37, eighth resistance element 38, and ninth resistance element 39 have the same resistance value of 1 kΩ.

When first switch 51 is in the conductive state, current from first battery 11 flows mainly in the order of first resistance element 31, second resistance element 32, first switch 51, fourth resistance element 34, and third resistance element 33 as indicated by arrow a. Thus, when first switch 51 is in the conductive state in battery management device 100, the power (capacity) of the first battery is consumed by the resistance elements (first resistance element 31 and third resistance element 33) on the wirings (first wiring 21 and second wiring 22) and by the resistance elements (second resistance element 32 and fourth resistance element 34) on substrate 160. In other words, in battery management device 100, the resistance elements that consume (discharge) the power are separately provided on the wirings and the substrate.

For example, when the voltage value of first battery 11 is 4.2 V, the current value of first battery 11 is represented by the following formula (1):

4.2 V/(10Ω+5Ω+5Ω+10Ω)=0.14 A (1)

The denominator on the left side of the formula (1) is the total value (=30Ω) of the resistance values of first resistance element 31, second resistance element 32, fourth resistance element 34, and third resistance element 33.

When first switch 51 is in the conductive state, first sensor 61 detects a voltage value (hereinafter also referred to as a “first voltage value”) of first battery 11 having been decreased in voltage by first resistance element 31 and third resistance element 33. That is, the first voltage value is represented by the following formula (2):

First voltage value=4.2 V−(20Ω×0.14 A)=1.4 V (2)

Further, second sensor 62 detects a voltage value (hereinafter also referred to as a “second voltage value”) of first battery 11 having been decreased in voltage by first to fourth resistance elements 31 to 34. That is, the second voltage value is represented by the following formula (3):

Second voltage value=4.2 V−(30Ω×0.14 A)=0 V (3)

The voltage values detected by first sensor 61 and second sensor 62 are output to controller 80 regardless of whether or not first switch 51 is in the conductive state. When the difference value between the first voltage value and the second voltage value is more than the voltage threshold value in the state in which first switch 51 is controlled to be in the conductive state, controller 80 determines that it is normal. On the other hand, when the difference value between the first voltage value and the second voltage value is less than the voltage threshold value (for example, when the first voltage value and the second voltage value are the same) in the state in which first switch 51 is controlled to be in the conductive state, controller 80 determines that an abnormality has occurred. Examples of the abnormality include abnormalities of first switch 51, first to fourth resistance elements 31 to 34, or the like. It should be noted that when the difference value is the same as the voltage threshold value, controller 80 may determine that it is abnormal or may determine that it is normal.

Further, when first switch 51 is in the non-conductive state, if battery management device 100 is normal, the current of arrow a does not flow. Therefore, when the difference value between the output value from first sensor 61 and the output value from second sensor 62 is smaller than the voltage threshold value in the state in which first switch 51 is controlled to be in the conductive state, controller 80 determines that it is normal. On the other hand, when first switch 51 is in the non-conductive state, if the difference value between the output value from first sensor 61 and the output value from second sensor 62 is larger than the voltage threshold value, it is determined that it is abnormal. Examples of this abnormality include such an abnormality that a below-described leakage current flows in the direction of arrow a even though first switch 51 is in the non-conductive state. It should be noted that when the difference value is the same as the voltage threshold value, controller 80 may determine that it is abnormal or may determine that it is normal.

Also when second switch 52 is controlled to be in the conductive state, the same process as the process when first switch 51 is controlled to be in the conductive state is performed.

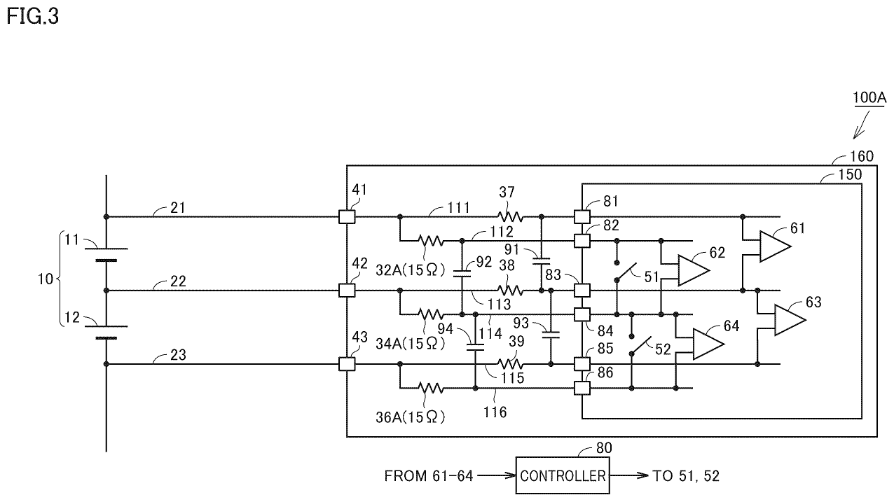

The following describes a result of comparison between battery management device 100 of the present embodiment and each of battery management devices of comparative examples. FIG. 3 is a diagram showing a configuration of a battery management device 100A according to a first comparative example. It should be noted that the example of FIG. 3 is different from that of FIG. 1 in that resistance elements (first resistance element 31, third resistance element 33, and fifth resistance element 35) are not disposed on wirings. Further, in FIG. 3, a second resistance element 32A, a fourth resistance element 34A, and a sixth resistance element 36A are shown as resistance elements respectively corresponding to second resistance element 32, fourth resistance element 34, and sixth resistance element 36 in FIG. 1. The resistance values of second resistance element 32A, fourth resistance element 34A, and sixth resistance element 36A are each set to 15Ω in order to consume the power of first battery 11 or second battery 12 as much as that in battery management device 100 when first switch 51 or second switch 52 comes into the conductive state.

Here, in battery management device 100A, when the voltage value of first battery 11 is 4.2 V, the current value of first battery 11 is 0.14 A as indicated in the above formula (1). Further, in battery management device 100A, when first switch 51 is brought into the conductive state, power is consumed by second resistance element 32A and fourth resistance element 34A. An amount of heat generated by second resistance element 32A and fourth resistance element 34A is represented by the following formula (4):

0.14 A×0.14 A×30Ω=0.588 W (4)

Thus, in battery management device 100A, all the resistance elements that consume the power are disposed on substrate 160. Further, when the current value of first battery 11 becomes large due to an increased size of first battery 11, an amount of heat generated by second resistance element 32A and fourth resistance element 34A becomes larger. Therefore, a substrate 160 having high heat resistance is required, thus resulting in high cost of battery management device 100A.

On the other hand, in battery management device 100, the resistance elements that consume (discharge) the power are separately provided on the wirings and the substrate as shown in FIG. 1. Hence, when first switch 51 is brought into the conductive state in battery management device 100, an amount of heat generated by the resistance elements on the wirings and an amount of heat generated by the resistance elements on substrate 160 are respectively represented by the following formulas (5) and (6):

0.14 A×0.14 A×20Ω=0.392 W (5)

0.14 A×0.14 A×10=0.196 W (6)

As apparent from the above formulas (4) and (6), the amount of heat generated in substrate 160 of battery management device 100 can be ⅓ of that in battery management device 100A. Therefore, substrate 160 having high heat resistance is not required, thereby suppressing the cost of battery management device 100.

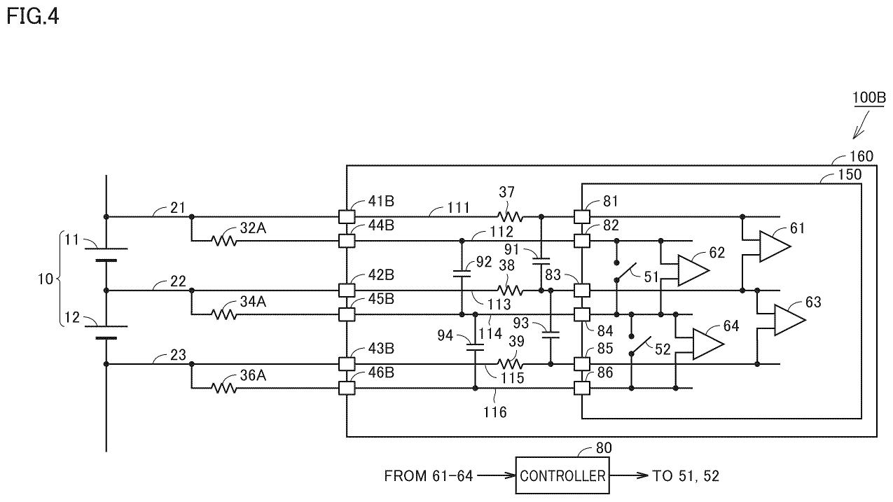

Further, in order to solve the problem of battery management device 100A of the first comparative example of FIG. 3 (such a problem that the amount of heat generated in substrate 160 becomes large), it is conceivable to employ the following configuration: second resistance element 32A, fourth resistance element 34A, and sixth resistance element 36A are disposed on the wirings. FIG. 4 is a diagram showing a configuration of a battery management device 100B of a second comparative example in which this configuration is employed.

In battery management device 100B of the second comparative example, two wirings from the positive electrode terminal of first battery 11 are constructed. Of the two wirings, one wiring is a wiring via which a voltage value is measured by first sensor 61, and the other wiring is a wiring via which a voltage value is measured by second sensor 62. Therefore, in battery management device 100B, six wirings are required, with the result that six terminals (a first terminal 41B, a second terminal 42B, a third terminal 43B, a fourth terminal 44B, a fifth terminal 45B, and a sixth terminal 46B) are required. This results in high cost of substrate 160.

On the other hand, in battery management device 100, part of the wiring via which first sensor 61 measures the voltage value, part of the wiring via which second sensor 62 measures the voltage value, and the wiring on which first resistance element 31 is disposed are also used as first wiring 21. Therefore, battery management device 100 may only have one terminal (first terminal 41) to correspond to first wiring 21, and does not require two terminals unlike battery management device 100B of FIG. 4. Therefore, the cost of substrate 160 can be reduced in battery management device 100 as compared with battery management device 100B.

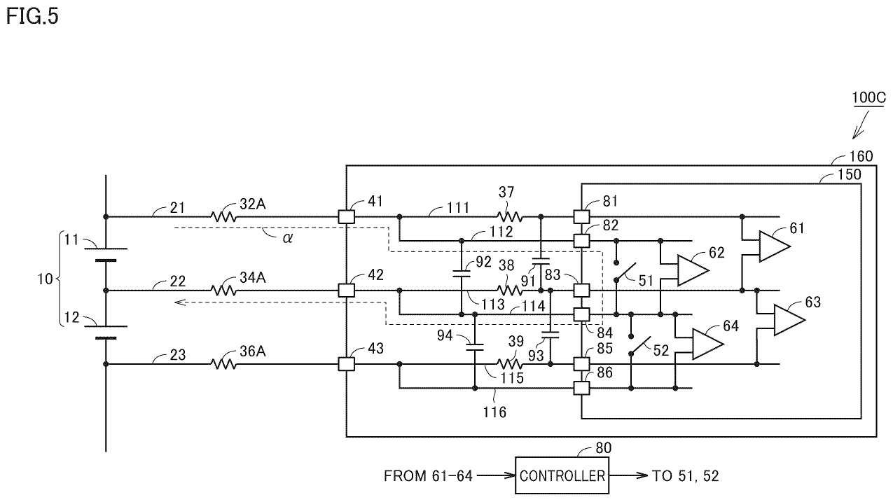

Further, in order to solve the problem of battery management device 100B of the second comparative example of FIG. 4 (such a problem that the number of terminals becomes large), it is conceivable to employ the following configuration: the same wiring is used for the wiring via which first sensor 61 detects the voltage value and the wring via which second sensor 62 detects the voltage value. FIG. 5 is a diagram showing a configuration of a battery management device 100C of a third comparative example in which this configuration is employed.

In battery management device 100C of the third comparative example, when first switch 51 is brought into the conductive state, the value of decrease of the voltage in the wiring via which first sensor 61 detects the voltage value is the same as that in the wiring via which second sensor 62 detects the voltage value. Hence, the voltage values detected by first sensor 61 and second sensor 62 are the same even when first switch 51 is brought into the conductive state or when a leakage current flows. Therefore, battery management device 100C cannot detect an abnormality.

On the other hand, the resistance value in the wiring via which first sensor 61 detects the voltage value is different from the resistance value in the wiring via which second sensor 62 detects the voltage value (see the above formulas (2) and (3)). Therefore, battery management device 100 can appropriately detect an abnormality.

First resistance element 31 is configured not to be failed even when a short circuit occurs between first terminal 41 and second terminal 42. Specifically, resistance value R1 of first resistance element 31 is preferably more than or equal to a value obtained by dividing, by a rated power value Pm of the first resistance element, a square value of a value obtained by prorating a maximum voltage value Vm of first battery 11 at a ratio r of the resistance value of first resistance element 31 and the resistance value of third resistance element 33. That is, resistance value R1 of first resistance element 31 is represented by the following formula (7):

R1≥(r×Vm)²/Pm (7)

Ratio r is a value resulting from the voltage of first battery 11 being divided by first resistance element 31 and third resistance element 33 when a short circuit occurs between first terminal 41 and second terminal 42. Further, in the example of FIG. 2, since the resistance values of first resistance element 31 and third resistance element 33 are the same, ratio r=½. Maximum voltage value Vm of first battery 11 is, for example, a voltage value when first battery 11 is fully charged, and it is assumed that Vm=4.2 V, for example. It is assumed that the rated power value of first resistance element 31 is 0.5 W. In this case, it is indicated that resistance value R1 of first resistance element 31 is preferably 8.82Ω or more by substituting these numerical values into the formula (7). It should be noted that an unintended short circuit in a short period of time due to manufacturing, maintenance, or the like is assumed in the formula (7) and therefore derating is not taken into consideration.

When the resistance value of first resistance element 31 satisfies the above formula (7), even if a short circuit occurs between first terminal 41 and second terminal 42, first resistance element 31 can be suppressed from being failed. Therefore, the cost of battery management device 100 can be reduced without requiring a device (for example, a fuse) that is operated when first terminal 41 and second terminal 42 are short-circuited.

Further, according to battery management device 100 of FIG. 1, the first ratio and the second ratio are the same. It should be noted that the expression “the same” in the present disclosure includes not only “completely the same” but also “substantially the same”.

The first ratio is a ratio of a total amount of heat radiated in first wiring 21 and second wiring 22 and an amount of heat radiated in substrate 160. The total amount of heat radiated in first wiring 21 and second wiring 22 is 0.392 W in the example of formula (5). Further, the amount of heat radiated in substrate 160 is 0.196 W in the example of the formula (6). That is, the first ratio is 2:1.

Meanwhile, the second ratio is a ratio of a total amount (20Ω) of the resistance values of first resistance element 31 and third resistance element 33 and a total amount (10Ω) of the resistance values of second resistance element 32 and fourth resistance element 34. That is, the second ratio is also 2:1, and the first ratio and the second ratio are the same.

Further, since the first ratio and the second ratio are the same, a designer for battery management device 100 can check a permissible amount of heat generated in each of the wirings (first wiring 21 and second wiring 22) and a permissible amount of heat generated in substrate 160, and can determine the resistance values of first resistance elements 31 to fourth resistance element 34 based on a ratio (corresponding to the first ratio) of these.

The first ratio may be a ratio of the amount of heat generated in first wiring 21 and the amount of heat generated in substrate 160. The second ratio may be a ratio of the resistance value of first resistance element 31 and the resistance value of second resistance element 32.

Further, when an abnormality (failure) of substrate 160 or the like occurs, a leakage current may occur. When a minimum current value determined as the leakage current is set to 1 mA, first sensor 61 detects a value that is decreased from the actual voltage of first battery 11 by 20 mV (=1 mA×20Ω) as indicated in the above formulas (2) and (3). Further, second sensor 62 detects a value that is decreased from the actual voltage of first battery 11 by 30 mV (=1 mA×30Ω). Therefore, a difference value between the voltage value detected by first sensor 61 and the voltage value detected by first sensor 61 is 10 mV.

When the difference value is 10 mV, the decreased voltage value of first sensor 61 can be 20 mV. When this 20 mV is regarded as a permissible error (tolerance) serving as accuracy of voltage measured by first sensor 61, the above-described voltage threshold value is set to 10 mV.

As described above, in battery management device 100, the ratio of the permissible error of first sensor 61 and the voltage threshold value is the same as the ratio of the resistance value (=10Ω) of the first resistance element and the resistance value (5Ω) of the second resistance element. Therefore, for example, the designer for battery management device 100 can determine the resistance values of first resistance element 31 and second resistance element 32 based on the ratio of the permissible error of first sensor 61 and the voltage threshold value.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery management device comprising:
a battery;
a substrate;
a switch;
a first wiring that connects the battery and the substrate;
a first resistance element disposed on the first wiring; and
a second resistance element disposed on the substrate, wherein
when the switch is in a conductive state, power of the battery is consumed by the first resistance element and the second resistance element.

2. The battery management device according to claim 1, wherein a ratio of an amount of heat generated in the first wiring and an amount of heat generated in the substrate is the same as a ratio of a resistance value of the first resistance element and a resistance value of the second resistance element.

3. The battery management device according to claim 1, further comprising a first sensor, a second sensor, and a controller that receives an input of a detection value of each of the first sensor and the second sensor, wherein
when the switch is in the conductive state, the first sensor outputs a first voltage value of the battery having been decreased in voltage by the first resistance element,
when the switch is in the conductive state, the second sensor outputs a second voltage value of the battery having been decreased in voltage by the first resistance element and the second resistance element, and
the controller detects an abnormality based on a difference value between the first voltage value and the second voltage value.

4. The battery management device according to claim 3, wherein
when the switch is in a non-conductive state, the controller detects the abnormality if the difference value is larger than a threshold value, and
a ratio of a permissible error of the first sensor and the threshold value is the same as a ratio of the resistance value of the first resistance element and the resistance value of the second resistance element.

5. The battery management device according to claim 1, wherein
the first wiring is connected to a positive electrode of the battery,
the battery management device further comprising:
one first terminal that connects the first wiring and the substrate;
a second wiring connected to a negative electrode of the battery; and
one second terminal that connects the second wiring and the substrate.

6. The battery management device according to claim 5, further comprising a third resistance element disposed on the second wiring, wherein
the resistance value of the first resistance element is more than or equal to a value obtained by dividing, by a rated power value of the first resistance element, a square value of a value obtained by prorating a maximum voltage value of the battery at a ratio of the resistance value of the first resistance element and a resistance value of the third resistance element.
